(19) United States
(12) Patent Application Publication
(10) Pub. No.: US 2012/0101782 A1
(43) Pub. Date: Apr. 26, 2012

(54) PROCESS AND APPARATUS FOR MEASURING SPECTRAL RESPONSE OF SOLAR CELL, AND PROCESS FOR COMPENSATING DECAY OF LIGHT SOURCE

(75) Inventors: Tsung-I Wang, Kuei-Shan Hsiang (TW); Ming-Chieh Lin, Kuei-Shan Hsiang (TW); Ching-Lin Lee, Kuei-Shan Hsiang (TW)

(73) Assignee: CHROMA ATE INC., Kuei-Shan Hsiang (TW)

(21) Appl. No.: 13/113,061

(22) Filed: May 22, 2011

(30) Foreign Application Priority Data
Oct. 20, 2010 (TW) 99135667

(51) Int. Cl. G06F 15/00

(52) U.S. Cl. 702/196

(57) ABSTRACT

The invention employs a group of LED devices as a light source for emitting light with different wavelengths towards the solar cell under test. A set of test signal data composed of mutually orthogonal test signals are used to power the LED devices to emit light. The solar cell, upon receiving light from the LED devices powered by the test signal data, generates detected values which are in turn converted into electric signals. A processor device is then used to separate component signals contributed by the respective LED devices from the signals and compare the component signals to the output power level corresponding to the test signal data and/or to the optical energy levels radiated from the respective LED devices, thereby obtaining the spectral response of the solar cell to the different wavelengths of light.

### FIELD OF THE INVENTION

The present invention relates to an apparatus and a process for evaluating a solar cell, and more particularly, to a process for measuring the spectral response of a solar cell, an apparatus for performing the measurement, and a process for compensating for the decay of a light source.

### DESCRIPTION OF THE RELATED ART

The exhaustion of fossil fuel reserves and the climate problems associated with carbon emissions have made global warming an increasingly serious issue of our time. As a result, some substitute energy resources, such as solar energy, wind energy and hydraulic energy, have been developed and their usage efficiency has been enhanced to answer the requirements for environmental protection. Among these substitute energy resources, solar energy is the most popular and promising one. Efforts have been made to increase the photoelectric conversion efficiency of solar cells—a measurement that is often used to evaluate the performance of solar cells. A 0.2% increase in photoelectric conversion efficiency could remarkably increase the prices of solar cells in the market.

FIG. 1 shows a solar spectrum. It is known that sunlight will undergo a change in its spectrum when it enters the atmosphere of the earth due to deflection and absorption by air. Such a change is also correlated to the incident angle of sunlight. For the purpose of standardization, a so-called standard solar spectrum is proposed to represent the spectral performance and overall energy value of sunlight after absorption by the atmosphere and serve as the overall energy reference value that could be received by a solar cell placed on the earth's surface, by using air mass (AM=1/cos θ) as a parameter.

As shown in FIG. 2, the parameter air mass (AM) is defined to be 1 when the sun radiates vertically at a solar zenith angle θ=0 from the sky right down to earth. Currently, the air mass 1.5 (AM 1.5G) solar spectrum is adopted as the standard simulated light source for solar cell efficiency measurements, which is intended to mimic a solar radiation at an incident angle of 48.2° relative to the norm line and is measured to have a total spectral flux of 963.75 W/m2. In the AM 1.5G standard solar spectrum, the sunlight energy is mainly distributed in the visible region.

Since the price of a solar cell is determined by its energy conversion efficiency, there is a need for a system for rapid and precise measurement of its energy conversion efficiency. However, neither the sun nor any artificial light source that simulates the sunlight spectrum emits light of a single wavelength. In theory, the energy conversion efficiency at each and every wavelength should be taken in account and calculated in a weighted manner, so as to precisely measure the energy conversion efficiency of a solar cell under test and obtain the actual response of the solar cell to the standard solar spectrum. On the other hand, if the artificial sunlight simulator used in the test has a poor precision, the results obtained thereby are certainly unreliable.

Unfortunately, it is practically difficult to achieve a light source having an emission spectrum that perfectly matches the standard AM 1.5G spectrum. Especially in the case where a high pressure discharge lamp is used as the light source, the problem tends to get worse over time when the brightness of the lamp decays due to aging and the light emitted therefrom shifts in wavelength. According to the European Standard IEC 60904-5, a laboratory sunlight simulator of Class A is defined to be one that has a spectrum differing from the standard solar spectrum by up to 25%. Given that the difference in percent efficiency between grades of solar cells is only 0.2%, it is still quite possible that solar cells are sorted into incorrect grades by using a Class A simulator.

One way to avoid the incorrect sorting described above is to measure the response of a solar cell at different wavelengths and then sum up the measured results in a weighted manner to thereby obtain a precise value for the overall energy conversion efficiency of the solar cell. A monochromator 10 shown in FIG. 3 is commonly used in laboratory operations to split an incident light into separate light beams with different wavelengths by adjusting the angles of the slits 11, 15, mirrors 12, 14 and grating 13 relative to one another, so that a particular wavelength of light is isolated. The particular wavelength of light is then split by a beam splitter (not shown) and directed to a standard plate with a known response to the wavelength of light (not shown) and a test subject (not shown). The response of the test subject to the wavelength of light is deduced by comparison of the magnitudes of output currents derived from the test subject and the standard plate. The actual spectral response of a solar cell over a range of wavelengths may therefore be obtained by collecting test data with respect to every wavelength in the range. However, this laboratory system requires mechanical adjustment of mirror angles and measurement of response to every wavelength within a range of interest. This system is not suitable for use in a solar cell production line due to low throughput and high manufacture cost.

Furthermore, assuming there are two solar cells which have identical values for overall energy conversion efficiency based upon the weighed calculation of the response to the AM 1.5G spectrum as described above and are therefore classified into the same grade, both of the solar cells may be incorporated into the same solar cell module, without considering the fact that one of them has a greater response to red light and the other exhibiting a better response to blue light. During a photoelectric conversion process, the two solar cells, when connected in series, will be hampered by each other due to their difference in spectral response, either in a blue light-rich or red light-rich environment. As a consequence, the amount of electricity generated in the module under any illumination condition appears to be less than that estimated from the sum of the electricity generated by individual solar cells, causing a reduced overall efficiency of energy conversion.

In other words, if the overall energy conversion efficiency of solar cells is taken into account as the only parameter during the grading of the solar cells, a solar cell module incorporated with a number of solar cells having different spectral responses would show a much lower efficiency than predicted.

Therefore, there is a need for a process and an apparatus that can rapidly and precisely measure the spectral response of a solar cell as a function of the energy conversion efficiency, so that the solar cell can be correctly evaluated and classified by substituting the response distribution to the AM 1.5G spectrum into the function to give the overall energy conversion efficiency and precisely classified. Advantageously, the correctly classified solar cells, when incorporated into the same solar cell module, will not be hampered by one another in terms of performance and, thus, the overall energy conversion efficiency of the solar cell module is as great as expected. The process and apparatus disclosed herein have additional advantages of high throughput measurement and high productivity and, therefore, are particularly suitable for use in an automatic production line for solar cells.

### SUMMARY OF THE INVENTION

Accordingly, an object of the present invention is to provide a process for precisely measuring the spectral response of a solar cell, so as to obtain a correct energy conversion efficiency of the solar cell.

Another object of the invention is to provide a process for precisely measuring the spectral response of a solar cell to a particular spectrum of light selected by the user, so that the energy conversion efficiency of the solar cell under illumination by the particular spectrum of light can be obtained.

It is still another object of the invention to provide a process for precisely measuring the spectral response of a solar cell, so that solar cells are delicately classified into classes under high quality control standards.

It is still another object of the invention to provide an apparatus for precisely measuring the spectral response of a solar cell.

It is still another object of the invention to provide an apparatus for measuring the spectral response of a solar cell, which is capable of precisely measuring and compensating for the decay of the respective LEDs mounted on the apparatus, thereby ensuring the precision of measurements using the light source.

It is still another object of the invention to provide an apparatus for measuring the spectral response of a solar cell, which is capable of precisely measuring the decay of the respective LEDs mounted on the apparatus and, when the decay can no longer be compensated for by elevating the luminous intensity of the respective LEDs, compensating for the decay by changing the gain ratios.

It is still another object of the invention to provide a light source, which meets the national standards for sunlight simulators and, therefore, is suitable for use in an apparatus for measuring the spectral response of a solar cell.

It is yet still another object of the invention to provide a light source, which is volatile enough to simulate any selected spectrum of light and, therefore, is suitable for use in an apparatus for measuring the spectral response of a solar cell.

The present invention therefore provides a process for measuring a spectral response of a solar cell by using a light-emitting diode (LED) array as a light source for emitting light towards the solar cell. The LED array comprises at least one group of LED devices, with each group having a plurality of LED devices. The LED devices are capable of emitting multiple types of light having different central wavelengths from one another, and the different types of light have a total number equal to or less than the total number of the LED devices. The process comprises the steps of:

a) powering the at least one group of LED devices to emit light in a synchronized manner by providing a set of test signal data composed of multiple test signals, wherein the test signals are mutually orthogonal to one another and have an output power level corresponding to at least one known power level;

b) converting detected values generated by the solar cell upon detecting light from the group of LED devices powered by the set of test signal data into detected electric signals; and

c) using a processor device to separate component signals contributed by the respective LED devices from the detected electric signals and compare the component signals to the output power level corresponding to the set of test signal data and/or to the respective optical energy levels radiated from the respective LED devices, thereby obtaining the spectral response of the solar cell to the different wavelengths of light.

The invention further provides an apparatus suitable for performing the measuring process described above. The apparatus comprises:

a light-emitting diode (LED) array comprising at least one group of LED devices with each group having a plurality of LED devices, wherein the LED devices are capable of emitting multiple types of light having different central wavelengths from one another and the different types of light have a total number equal to or less than the total number of the LED devices;

a driver device for powering the at least one group of LED devices to emit light in a synchronized manner by providing a set of test signal data composed of multiple test signals, wherein the test signals are mutually orthogonal to one another and have an output power level corresponding to at least one known power level; and

a processor device for converting detected values generated by the solar cell upon detecting light from the group of LED devices powered by the set of test signal data into detected electric signals, and for separating component signals contributed by the respective LED devices from the detected electric signals and comparing the component signals to the output power level corresponding to the set of test signal data and/or to the respective optical energy levels radiated from the respective LED devices, thereby obtaining the spectral response of the solar cell to the different wavelengths of light.

The invention further provides a process for compensating for the decay of a light source. The process includes a step h) of separating the component signals contributed by the respective LED devices and comparing the component signals to the reference spectral response values. The step h) comprises the sub-steps of:

h1) multiplying the respective test signals of the test signal data with the detected electric signals, so that portions of the detected electric signals which are orthogonal to the test signals multiplied therewith and noise portions of the detected electric signals which are independent from the test signals are calibrated to be zero;

h2) comparing the respective component signals corresponding to the respective test signals to the reference spectral response values corresponding to the standard light source, and defining the deviations of luminous intensity of the light source with respect to the respective central wavelengths of light emitted from the respective LED devices powered according to the respective test signals; and

h3) performing calculation with respect to the respective central wavelengths of light to obtain the deviations of luminous intensity of the light source over all of the different central wavelengths.

The invention disclosed herein involves using a number of switch units to control the respective LEDs to emit light with particular wavelengths and acquiring the spectral response of a solar cell to the particular wavelengths of light with high signal-to-noise ratio by taking advantage of the characteristics of orthogonal codes. The invention further involves comparing the measured values to reference values, thereby obtaining the degree of decay and further compensating for the decay. The invention offers higher throughput for measurement of solar cells as compared to the traditional monochromatic measurement systems and achieves the objects described above accordingly.

### BRIEF DESCRIPTION OF THE DRAWINGS

The above and other objects, features and effects of the invention will become apparent with reference to the following description of the preferred embodiments taken in conjunction with the accompanying drawings, in which:

FIG. 1 shows a spectrum distribution of sunlight;

FIG. 2 is a schematic diagram showing that the sun radiates from the sky to the earth and the definition of air mass (AM);

FIG. 3 is a schematic diagram of a monochromator which is conventionally used to measure the response of a solar cell to different wavelengths;

FIG. 4 is a block diagram showing the system according to the first preferred embodiment of the invention;

FIG. 5 is a schematic diagram showing the light source used in the system of FIG. 4;

FIG. 6 is a schematic diagram showing an LED device used in the system of FIG. 4 and the driver device coupled thereto;

FIG. 7 is a flowchart showing the steps of the measurement using the system of FIG. 4;

FIG. 8 is a schematic diagram of the LED devices according to the second preferred embodiment of the invention; and

FIG. 9 is a flowchart showing the steps of compensating for the decay of the light source.

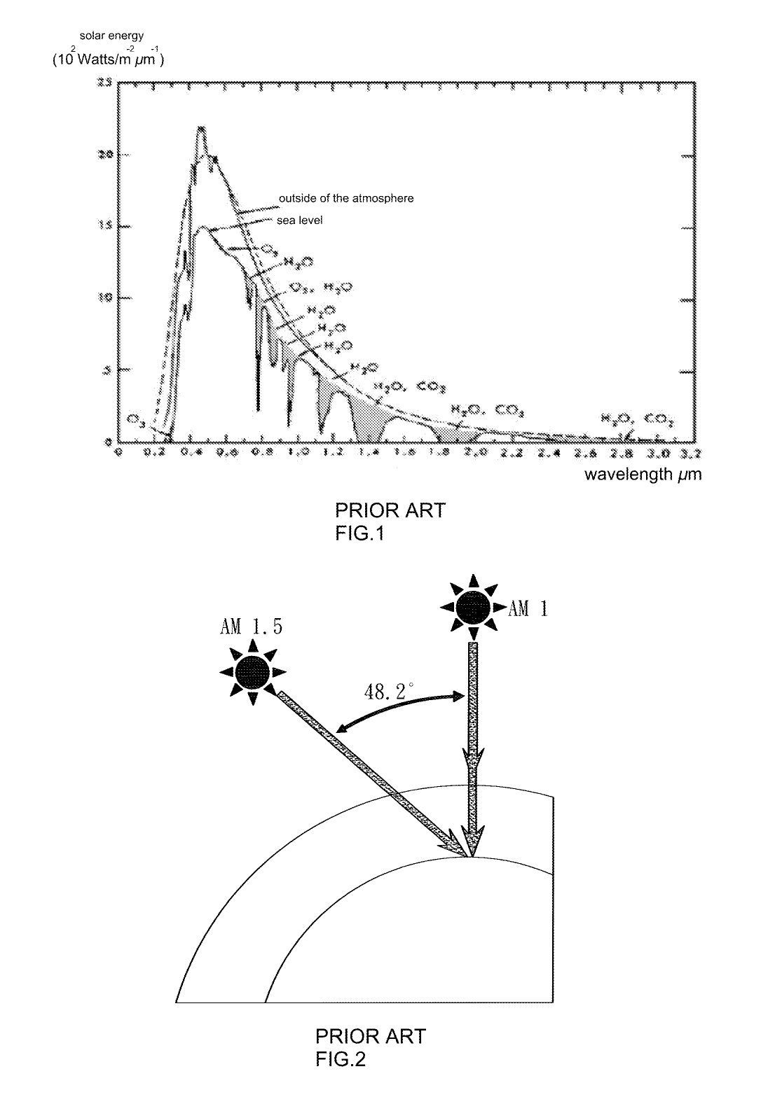

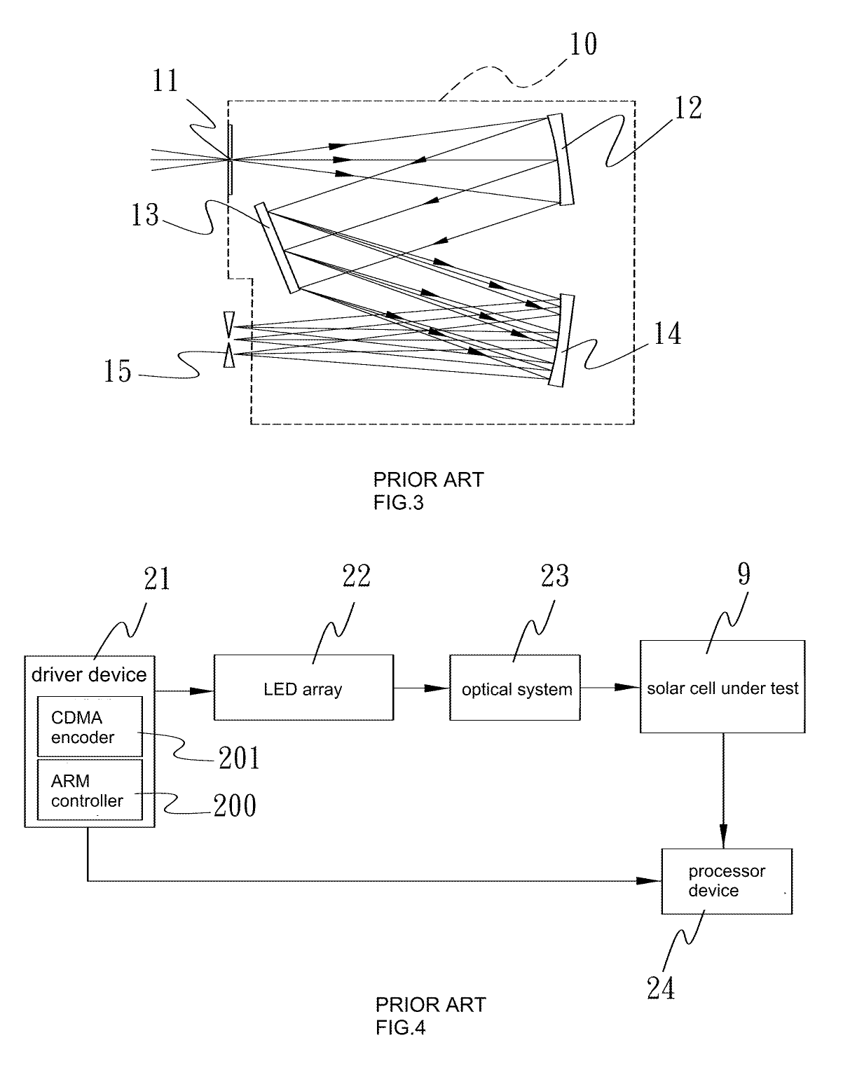

### DETAILED DESCRIPTION OF THE INVENTION

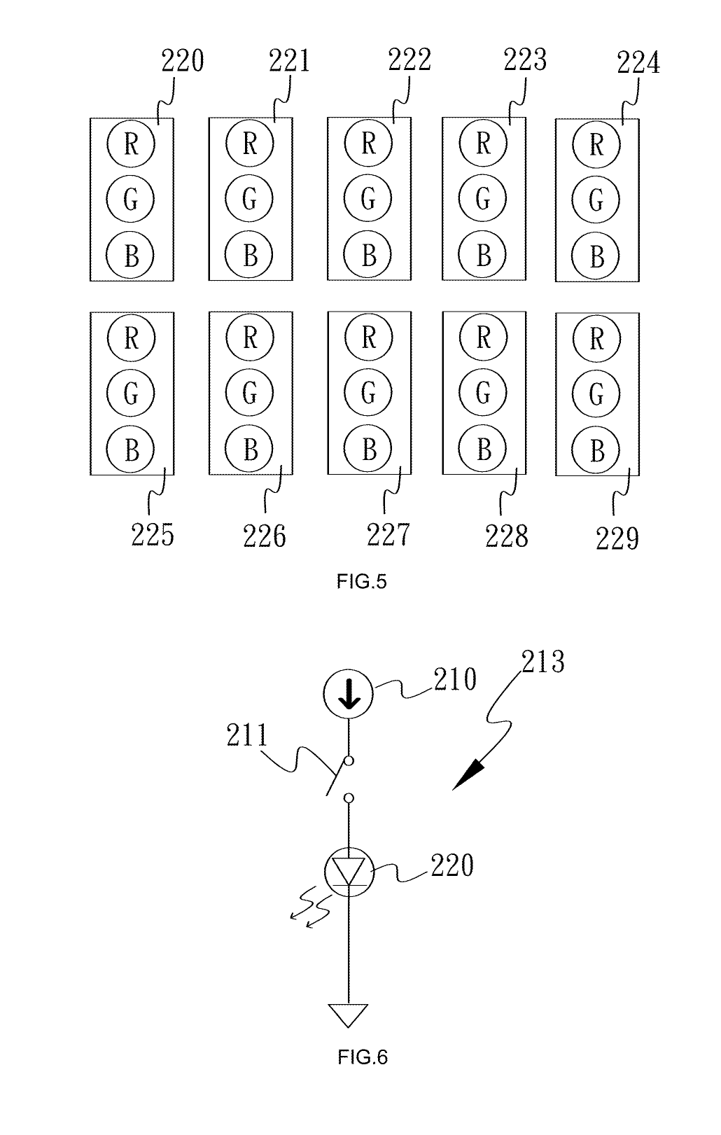

An apparatus for measuring the spectral response of a solar cell according to the invention is shown in FIG. 4, which comprises an LED light source. As show in FIG. 5, the LED light source used herein for measuring the respective responses of a solar cell 9 to red, green and blue light includes an LED array 22 composed of 10 sets of LED devices 220, 221, . . . 229, each set being provided with a red-light LED device, a green-light LED device and a blue-light LED device designated as 220R, 220G, 220B, . . . 229B, respectively. Each of the LED devices is coupled to a driver circuit 213 as shown in FIG. 6. The driver circuit 213 includes a switch unit 211 for operatively connecting the LED device to a current source 210 by being placed in the ON state, thereby permitting the LED device to emit light.

Under illumination from a light source, the spectral response of a solar cell can be obtained by assigning test signal data to the respective LED devices. The test signal data are generated in the form of orthogonal codes derived from a Walsh matrix and used to produce optical pulse sequences. The Walsh matrix disclosed herein is an orthogonal matrix with a dimension of 2^{k}. With a recursive equation kεN:

$$H ( {2}^{0} ) = [ 1 ] , \\ H ( {2}^{1} ) = [ \begin{matrix}1 & 1 \\ 1 & - 1\end{matrix} ] , \\ H ( {2}^{2} ) = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ] ,$$

the 2^{k}-dimensional expression of the matrix can be written as follows:

$$H ( {2}^{k} ) = [ \begin{matrix}H ( {2}^{k - 1} ) & H ( {2}^{k - 1} ) \\ H ( {2}^{k - 1} ) & - H ( {2}^{k - 1} )\end{matrix} ] = H ( 2 ) ⊗ H ( {2}^{k - 1} ) ,$$

In this embodiment, thirty LED devices are arranged in a repeated order of R, G, B and assigned serial numbers. Each of the LED devices is governed by a test signal data. The total number of the “mutually orthogonal” driving signals should be at least equal to the number of the LED devices, so that any of the test signal data will not repeat itself. As illustrated herein, the total number of the “mutually orthogonal” signals is 2^{k}=32. Exclusive of the permutation including purely 1 in the first line, there are 30 sets of orthogonal codes assigned to the respective LED devices according to this embodiment, as listed below.

$${a}_{1} = [ \begin{matrix}1 & - 1 & 1 & - 1 & 1 & - 1 & 1 & - 1 & 1 & - 1 & 1 & - 1 & 1 & - 1 & 1 & - 1 & 1 \\ - 1 & 1 & - 1 & 1 & - 1 & 1 & - 1 & 1 & - 1 & 1 & - 1 & 1 & - 1 & 1 & - 1 & & \end{matrix} ]$$

$${a}_{2} = [ \begin{matrix}1 & 1 & - 1 & - 1 & 1 & 1 & - 1 & - 1 & 1 & 1 & - 1 & - 1 & 1 & 1 & - 1 & - 1 & 1 \\ 1 & - 1 & - 1 & 1 & 1 & - 1 & - 1 & 1 & 1 & - 1 & - 1 & 1 & 1 & - 1 & - 1 & & \end{matrix} ]$$

$${a}_{3} = [ \begin{matrix}1 & - 1 & - 1 & 1 & 1 & - 1 & - 1 & 1 & 1 & - 1 & - 1 & 1 & 1 & - 1 & - 1 & 1 & 1 \\ - 1 & - 1 & 1 & 1 & - 1 & - 1 & 1 & 1 & - 1 & - 1 & 1 & 1 & - 1 & - 1 & 1 & & \end{matrix} ]$$

$${a}_{4} = [ \begin{matrix}1 & 1 & 1 & 1 & - 1 & - 1 & - 1 & - 1 & 1 & 1 & 1 & 1 & - 1 & - 1 & - 1 & - 1 & 1 \\ 1 & 1 & 1 & - 1 & - 1 & - 1 & - 1 & 1 & 1 & 1 & 1 & - 1 & - 1 & - 1 & - 1 & & \end{matrix} ]$$

$${a}_{5} = [ \begin{matrix}1 & - 1 & 1 & - 1 & - 1 & 1 & - 1 & 1 & 1 & - 1 & 1 & - 1 & - 1 & 1 & - 1 & 1 & 1 \\ - 1 & 1 & - 1 & - 1 & 1 & - 1 & 1 & 1 & - 1 & 1 & - 1 & - 1 & 1 & - 1 & 1 & & \end{matrix} ]$$

$${a}_{6} = [ \begin{matrix}1 & 1 & - 1 & - 1 & - 1 & - 1 & 1 & 1 & 1 & 1 & - 1 & - 1 & - 1 & - 1 & 1 & 1 & 1 \\ 1 & - 1 & - 1 & - 1 & - 1 & 1 & 1 & 1 & 1 & - 1 & - 1 & - 1 & - 1 & 1 & 1 & & \end{matrix} ]$$

$${a}_{7} = [ \begin{matrix}1 & - 1 & - 1 & 1 & - 1 & 1 & 1 & - 1 & 1 & - 1 & - 1 & 1 & - 1 & 1 & 1 & - 1 & 1 \\ - 1 & - 1 & 1 & - 1 & 1 & 1 & - 1 & 1 & - 1 & - 1 & 1 & - 1 & 1 & 1 & - 1 & & \end{matrix} ]$$

$${a}_{8} = [ \begin{matrix}1 & 1 & 1 & 1 & 1 & 1 & 1 & 1 & - 1 & - 1 & - 1 & - 1 & - 1 & - 1 & - 1 & - 1 & 1 \\ 1 & 1 & 1 & 1 & 1 & 1 & 1 & - 1 & - 1 & - 1 & - 1 & - 1 & - 1 & - 1 & - 1 & & \end{matrix} ]$$

$${a}_{9} = [ \begin{matrix}1 & - 1 & 1 & - 1 & 1 & - 1 & 1 & - 1 & - 1 & 1 & - 1 & 1 & - 1 & 1 & - 1 & 1 & 1 \\ - 1 & 1 & - 1 & 1 & - 1 & 1 & - 1 & - 1 & 1 & - 1 & 1 & - 1 & 1 & - 1 & 1 & & \end{matrix} ]$$

$${a}_{10} = [ \begin{matrix}1 & 1 & - 1 & - 1 & 1 & 1 & - 1 & - 1 & - 1 & - 1 & 1 & 1 & - 1 & - 1 & 1 & 1 & 1 \\ 1 & - 1 & - 1 & 1 & 1 & - 1 & - 1 & - 1 & - 1 & 1 & 1 & - 1 & - 1 & 1 & 1 & & \end{matrix} ]$$

$${a}_{11} = [ \begin{matrix}1 & - 1 & - 1 & 1 & 1 & - 1 & - 1 & 1 & - 1 & 1 & 1 & - 1 & - 1 & 1 & 1 & - 1 & 1 \\ - 1 & - 1 & 1 & 1 & - 1 & - 1 & 1 & - 1 & 1 & 1 & - 1 & - 1 & 1 & 1 & - 1 & & \end{matrix} ]$$

$${a}_{12} = [ \begin{matrix}1 & 1 & 1 & 1 & - 1 & - 1 & - 1 & - 1 & - 1 & - 1 & - 1 & - 1 & 1 & 1 & 1 & 1 & 1 \\ 1 & 1 & 1 & - 1 & - 1 & - 1 & - 1 & - 1 & - 1 & - 1 & - 1 & 1 & 1 & 1 & 1 & & \end{matrix} ]$$

$${a}_{13} = [ \begin{matrix}1 & - 1 & 1 & - 1 & - 1 & 1 & - 1 & 1 & - 1 & 1 & - 1 & 1 & 1 & - 1 & 1 & - 1 & 1 \\ - 1 & 1 & - 1 & - 1 & 1 & - 1 & 1 & - 1 & 1 & - 1 & 1 & 1 & - 1 & 1 & - 1 & & \end{matrix} ]$$

$${a}_{14} = [ \begin{matrix}1 & 1 & - 1 & - 1 & - 1 & - 1 & 1 & 1 & - 1 & - 1 & 1 & 1 & 1 & 1 & - 1 & - 1 & 1 \\ 1 & - 1 & - 1 & - 1 & - 1 & 1 & 1 & - 1 & - 1 & 1 & 1 & 1 & 1 & - 1 & - 1 & & \end{matrix} ]$$

$${a}_{15} = [ \begin{matrix}1 & - 1 & - 1 & 1 & - 1 & 1 & 1 & - 1 & - 1 & 1 & 1 & - 1 & 1 & - 1 & - 1 & 1 & 1 \\ - 1 & - 1 & 1 & - 1 & 1 & 1 & - 1 & - 1 & 1 & 1 & - 1 & 1 & - 1 & - 1 & 1 & & \end{matrix} ]$$

$${a}_{16} = [ \begin{matrix}1 & 1 & 1 & 1 & 1 & 1 & 1 & 1 & 1 & 1 & 1 & 1 & 1 & 1 & 1 & 1 & - 1 \\ - 1 & - 1 & - 1 & - 1 & - 1 & - 1 & - 1 & - 1 & - 1 & - 1 & - 1 & - 1 & - 1 & - 1 & - 1 & & \end{matrix} ]$$

$${a}_{17} = [ \begin{matrix}1 & - 1 & 1 & - 1 & 1 & - 1 & 1 & - 1 & 1 & - 1 & 1 & - 1 & 1 & - 1 & 1 & - 1 & - 1 \\ 1 & - 1 & 1 & - 1 & 1 & - 1 & 1 & - 1 & 1 & - 1 & 1 & - 1 & 1 & - 1 & 1 & & \end{matrix} ]$$

$${a}_{18} = [ \begin{matrix}1 & 1 & - 1 & - 1 & 1 & 1 & - 1 & - 1 & 1 & 1 & - 1 & - 1 & 1 & 1 & - 1 & - 1 & - 1 \\ - 1 & 1 & 1 & - 1 & - 1 & 1 & 1 & - 1 & - 1 & 1 & 1 & - 1 & - 1 & 1 & 1 & & \end{matrix} ]$$

$${a}_{19} = [ \begin{matrix}1 & - 1 & - 1 & 1 & 1 & - 1 & - 1 & 1 & 1 & - 1 & - 1 & 1 & 1 & - 1 & - 1 & 1 & - 1 \\ 1 & 1 & - 1 & - 1 & 1 & 1 & - 1 & - 1 & 1 & 1 & - 1 & - 1 & 1 & 1 & - 1 & & \end{matrix} ]$$

$${a}_{20} = [ \begin{matrix}1 & 1 & 1 & 1 & - 1 & - 1 & - 1 & - 1 & 1 & 1 & 1 & 1 & - 1 & - 1 & - 1 & - 1 & - 1 \\ - 1 & - 1 & - 1 & 1 & 1 & 1 & 1 & - 1 & - 1 & - 1 & - 1 & 1 & 1 & 1 & 1 & & \end{matrix} ]$$

$${a}_{21} = [ \begin{matrix}1 & - 1 & 1 & - 1 & - 1 & 1 & - 1 & 1 & 1 & - 1 & 1 & - 1 & - 1 & 1 & - 1 & 1 & - 1 \\ 1 & - 1 & 1 & 1 & - 1 & 1 & - 1 & - 1 & 1 & - 1 & 1 & 1 & - 1 & 1 & - 1 & & \end{matrix} ]$$

$${a}_{22} = [ \begin{matrix}1 & 1 & - 1 & - 1 & - 1 & - 1 & 1 & 1 & 1 & 1 & - 1 & - 1 & - 1 & - 1 & 1 & 1 & - 1 \\ - 1 & 1 & 1 & 1 & 1 & - 1 & - 1 & - 1 & - 1 & 1 & 1 & 1 & 1 & - 1 & - 1 & & \end{matrix} ]$$

$${a}_{23} = [ \begin{matrix}1 & - 1 & - 1 & 1 & - 1 & 1 & 1 & - 1 & 1 & - 1 & - 1 & 1 & - 1 & 1 & 1 & - 1 & - 1 \\ 1 & 1 & - 1 & 1 & - 1 & - 1 & 1 & - 1 & 1 & 1 & - 1 & 1 & - 1 & - 1 & 1 & & \end{matrix} ]$$

$${a}_{24} = [ \begin{matrix}1 & 1 & 1 & 1 & 1 & 1 & 1 & 1 & - 1 & - 1 & - 1 & - 1 & - 1 & - 1 & - 1 & - 1 & - 1 \\ - 1 & - 1 & - 1 & - 1 & - 1 & - 1 & - 1 & 1 & 1 & 1 & 1 & 1 & 1 & 1 & 1 & & \end{matrix} ]$$

$${a}_{25} = [ \begin{matrix}1 & - 1 & 1 & - 1 & 1 & - 1 & 1 & - 1 & - 1 & 1 & - 1 & 1 & - 1 & 1 & - 1 & 1 & - 1 \\ 1 & - 1 & 1 & - 1 & 1 & - 1 & 1 & 1 & - 1 & 1 & - 1 & 1 & - 1 & 1 & - 1 & & \end{matrix} ]$$

$${a}_{26} = [ \begin{matrix}1 & 1 & - 1 & - 1 & 1 & 1 & - 1 & - 1 & - 1 & - 1 & 1 & 1 & - 1 & - 1 & 1 & 1 & - 1 \\ - 1 & 1 & 1 & - 1 & - 1 & 1 & 1 & 1 & 1 & - 1 & - 1 & 1 & 1 & - 1 & - 1 & & \end{matrix} ]$$

$${a}_{27} = [ \begin{matrix}1 & - 1 & - 1 & 1 & 1 & - 1 & - 1 & 1 & - 1 & 1 & 1 & - 1 & - 1 & 1 & 1 & - 1 & - 1 \\ 1 & 1 & - 1 & - 1 & 1 & 1 & - 1 & 1 & - 1 & - 1 & 1 & 1 & - 1 & - 1 & 1 & & \end{matrix} ]$$

$${a}_{28} = [ \begin{matrix}1 & 1 & 1 & 1 & - 1 & - 1 & - 1 & - 1 & - 1 & - 1 & - 1 & - 1 & 1 & 1 & 1 & 1 & - 1 \\ - 1 & - 1 & - 1 & 1 & 1 & 1 & 1 & 1 & 1 & 1 & 1 & - 1 & - 1 & - 1 & - 1 & & \end{matrix} ]$$

$${a}_{29} = [ \begin{matrix}1 & - 1 & 1 & - 1 & - 1 & 1 & - 1 & 1 & - 1 & 1 & - 1 & 1 & 1 & - 1 & 1 & - 1 & - 1 \\ 1 & - 1 & 1 & 1 & - 1 & 1 & - 1 & 1 & - 1 & 1 & - 1 & - 1 & 1 & - 1 & 1 & & \end{matrix} ]$$

$${a}_{30} = [ \begin{matrix}1 & 1 & - 1 & - 1 & - 1 & - 1 & 1 & 1 & - 1 & - 1 & 1 & 1 & 1 & 1 & - 1 & - 1 & - 1 \\ - 1 & 1 & 1 & 1 & 1 & - 1 & - 1 & 1 & 1 & - 1 & - 1 & - 1 & - 1 & 1 & 1 & & \end{matrix} ]$$

In the orthogonal codes listed above, the digit 1 represents a corresponding LED device being in the ON state where it is powered to emit light, whereas the digit −1 represents the corresponding LED device being placed in the OFF state where it doe not emit light. The test signal data further govern a current I=Ii for powering the respective LED devices to emit light when they are placed in the ON state, wherein i=1, 2, . . . , 30. There is no current flowing to the respective LED devices when they are in the OFF state.

In the case where the bit number N=2^{k}=32 and there exists n number of serial numbers, all of the driving signals aᵢ (n) should satisfy the following equations:

$$\begin{matrix}{\sum }_{n = 1}^{N} {a}_{i} ( n ) = 0 & Equation ( 1 ) \\ {\sum }_{n = 1}^{N} {a}_{i}^{2} ( n ) = N & Equation ( 2 ) \\ {\sum }_{n = 1}^{N} {a}_{i} ( n ) {a}_{j} ( n ) = 0 ( i \neq j ) ; i , j = 1 , 2 … , 30 & Equation ( 3 )\end{matrix}$$

Taking advantage of the mathematical equations described above, even if multiple LED devices are powered to emit light towards a solar cell during the same period of time and then combined and converted into time-varying current signals, the respective signals can still be retrieved and read out by demodulation according to the method described below. The respective LED devices will not interfere with one another and are subjected to multiple access at the same time. The multiple access leads to an approximately 2^{k}-fold increase in test rate as compared to the conventional process in which LED devices are tested in an one-by-one manner.

The solar cell receives light from the LED light source via an optical system 23 and converts the same into a response current which is output in the form of electric signals. The magnitude of the response current is referred to herein as Iₒ. It is assumed that the light emitted from the LED device driven by the test signals aᵢ (n) is detected in a clock sequence of n=1, 2, . . . N to have a value equal to ½ Iᵢ(1+aᵢ(n))(n=1, 2, . . . N), then the solar cell, upon detecting the light emission from the thirty LED devices powered and modulated by the “mutually orthogonal” driving signals a₁ (n), a₂ (n), . . . a₃₀ (n), will generate a summed electric signal S(n)=

$${\sum }_{i = 1}^{30} \frac{1}{2} {I}_{i} ( 1 + {a}_{i} ( n ) ) ,$$

wherein n=1, 2, . . . 32 and i=1, 2, . . . 30.

Next, the respective current values generated by lighting the respective LED devices 220R, 220G, 220B, . . . 229B are recovered. For example, given that the lighting of the LED device a₁ results in a time-varying current signal I₁,

$${\sum }_{n = 1}^{32} S ( n )$$

is multiplied by a₁ (n) according to the following relationship:

$$\begin{matrix}{\sum }_{n = 1}^{32} S ( n ) {a}_{1} ( n ) = {\sum }_{n = 1}^{32} {\sum }_{i = 1}^{30} \frac{1}{2} ( 1 + {a}_{1} ( n ) ) {I}_{i} \cdot {a}_{1} ( n ) \\ = \frac{1}{2} {\sum }_{n = 1}^{32} {\sum }_{i = 1}^{30} {I}_{i} {a}_{1} ( n ) + \frac{1}{2} {\sum }_{n = 1}^{32} {\sum }_{i = 1}^{30} {I}_{i} {a}_{i} ( n ) {a}_{1} ( n ) \\ = \frac{1}{2} {\sum }_{i = 1}^{30} {\sum }_{n = 1}^{32} {a}_{1} ( n ) + \frac{1}{2} {\sum }_{i = 1}^{30} {I}_{i} {\sum }_{n = 1}^{32} {a}_{i} ( n ) {a}_{1} ( n ) \\ = \frac{1}{2} {\sum }_{i = 1}^{30} {I}_{i} \cdot 0 + \frac{1}{2} {\sum }_{i = 1}^{30} {I}_{i} {δ}_{i 1} \cdot 32 \\ = 0 + \frac{1}{2} {I}_{i} \cdot 32 = 16 {I}_{1} ,\end{matrix}$$

$$and gives$$

$${I}_{1} = \frac{1}{16} {\sum }_{n = 1}^{32} S ( n ) {a}_{1} ( n ) .$$

Similarly, the processing of

$${\sum }_{n = 1}^{32} S ( n ) {a}_{2} ( n )$$

gives 16 I₂. Therefore, from the summed electric signal generated by the solar cell 9 in response to the illumination from the LED devices 220R, 220G, 220B, . . . 229B, the respective current values generated by lighting the thirty LED devices 220R, 220G, 220B, . . . 229B are demodulated based upon the relationship

$${I}_{k} = \frac{1}{16} {\sum }_{n = 1}^{32} S ( n ) {a}_{k} ( n ) .$$

The respective luminous intensities of the LED devices 220R, 220G, 220B, . . . 229B are calculated from the magnitudes of electric current that drive the respective LED devices to emit light, and then compared with the individual current values that are generated by the solar cell 9 responsive to receiving illumination from the respective LED devices 220R, 220G, 220B, . . . 229B and separated from the summed electric signal Iₒ as described above, so as to obtain the spectral response to different wavelengths of light.

In particular, a “mutually orthogonal” series of driving signals are used to modulate the respective LED devices, and the respective driving signals in the “mutually orthogonal” series are subsequently used to multiply with the summed electric signal to accomplish a synchronized demodulation. Given that the synchronized demodulation algorithm includes a step of multiplying the respective driving signals back with the summed electric signal, and that each of the driving signals has exactly half of the bit values equal to +1 and the other half equal to −1, the ambient signals which are asynchronous with the driving signals and interfere with the detected result of the solar cell 9 will be demodulated in clock sequence during the demodulation process, with half of them being multiplied with +1 and the other half with −1. The adverse effects caused by the ambient signals are significantly reduced after processing, and this is particularly true as the bit number in a driving signal byte increases. Therefore, the embodiment disclosed herein may further perform an anti-noise function.

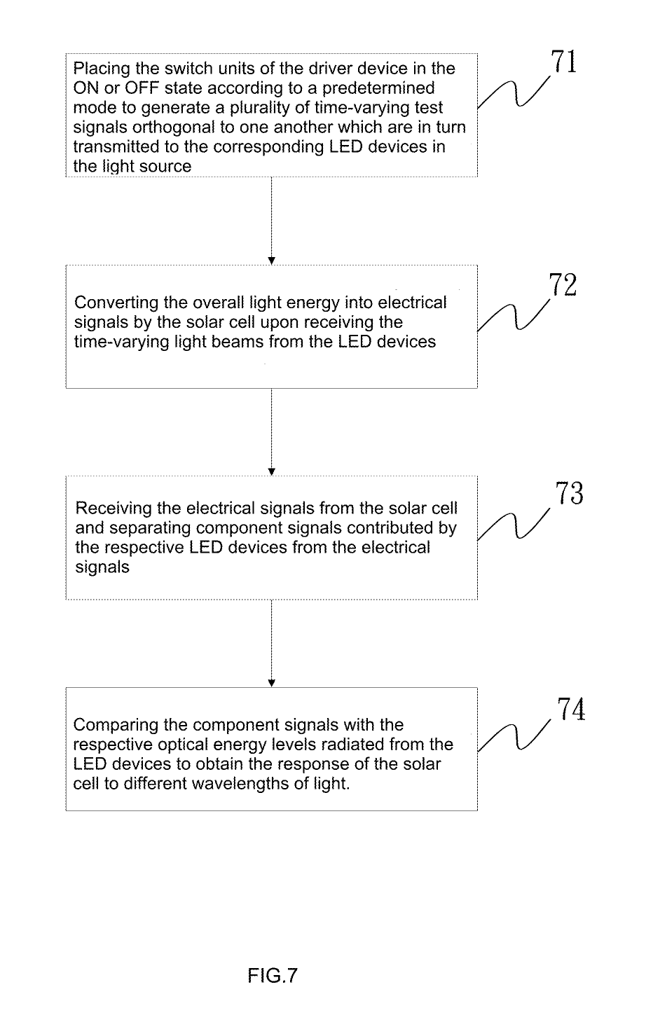

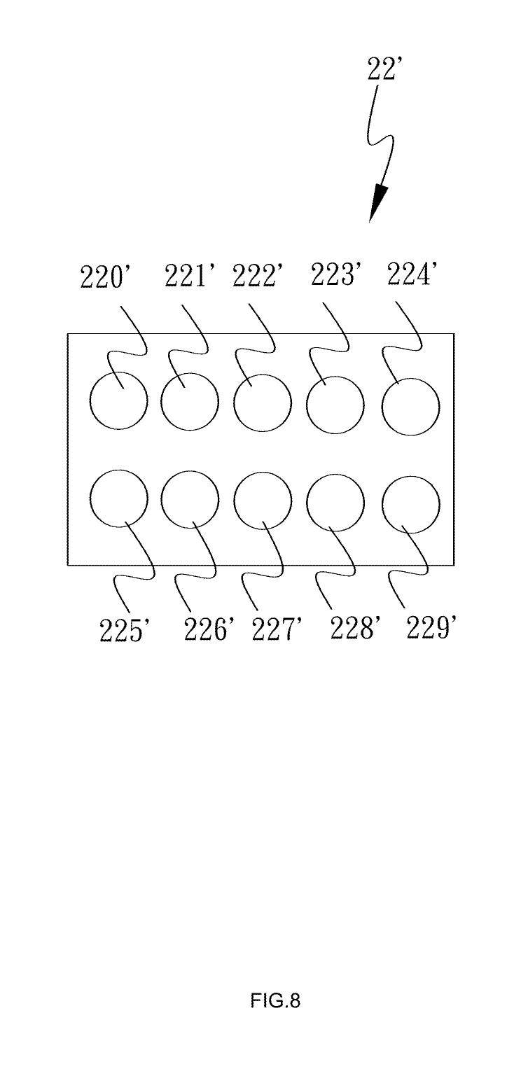

The process for measuring the spectral response of a solar cell in accordance with the invention is generally illustrated in the flowchart of FIG. 7. As illustrated in Step 71, the driver circuits of the driver device 21 supply an electrical current of a known power level to the respective LED devices 220R, 220G, 220B, . . . 229B, and the switch units 211 of the driver device 21 are placed in the ON or OFF state according to the predetermined mode described above, thereby generating a plurality of time-varying test signals orthogonal to one another which are in turn transmitted to the corresponding LED devices 220R, 220G, 220B, . . . 229B. It is apparent to those skilled in the art that the invention is also applicable to the case where the respective LED devices 220R, 220G, 220B, . . . 229B are provided with test signals of different power levels.

Next, in Step 72, the time-varying light beams emitted from the LED devices 220R, 220G, 220B, . . . 229B are received by the solar cell 9, where the overall light energy received is converted into electrical signals. In Step 73, the electrical signals output from the solar cell 9 are transmitted to a processor device 24, where the component signals contributed by the respective LED devices 220R, 220G, 220B, . . . 229B are separated from the electrical signals. In Step 74, the component signals are compared to the respective optical energy levels radiated from the LED devices 220R, 220G, 220B, . . . 229B, with each of the LED devices emitting light with a known central wavelength, and from there the response of the solar cell 9 over a range of light wavelengths is obtained.

It will be readily appreciated by those skilled in the art that the sun emits light over a broad range of wavelengths, not only over the visible region. Therefore, only measuring the response of a solar cell to visible light, such as to the red, green and blue light wavelengths perceptible by human eyes, appears insufficient for the purposes of the invention. As disclosed herein, the apparatus for measuring the spectral response of a solar cell may by way of example be equipped with a light source shown in FIG. 8. The light source includes an array 22′ of ten LED devices capable of emitting light with different central wavelengths, comprising an ultraviolet LED device 220′ emitting light at a wavelength ranging from 360 to 380 nm, a green-light LED device 221′ emitting light at a wavelength ranging from 380 to 430 nm, a blue-light LED device emitting light at a wavelength ranging from 430 to 480 nm, a cyan-light LED device 223′ emitting light at a wavelength ranging from 480 to 500 nm, a green-light LED device 224′ emitting light at a wavelength ranging from 500 to 550 nm, a yellowish green-light LED device 225′ emitting light at a wavelength ranging from 550 to 580 nm, a yellow-light LED device 226′ emitting light at a wavelength ranging from 580 to 595 nm, an amber-light LED device 227′ emitting light at a wavelength ranging from 595 to 605 nm, an orange-light LED device 228′ emitting light at a wavelength ranging from 605 to 620 nm, and a red-light and near-infrared-light LED device 229′ emitting light at a wavelength ranging from 620 to 780 nm. When three LED arrays are mounted in the inventive apparatus, there are a totality of thirty LED devices included to one-to-one correspond to the mutually orthogonal driving signals described above.

According to this embodiment, the driver device 21 includes an ARM controller 201 and a CDMA (code-division multiple access) encoder 200. In this case, 32 sets of Walsh orthogonal codes generated based on the CDMA technology are employed as the driving signals, in which the digit 1 is directed to a high level portion that allows the corresponding LED device to emit light and the complementary −1 indicates a low level portion that applies a ground voltage to the LED device and will not cause lighting of the LED device. Therefore, the respective LED devices are rapidly placed in either a bright state or a dark state upon being driven by the mutually orthogonal driving signals.

Meanwhile, the ARM controller 201 synchronously transmits the signals to the processor device 24 to ensure a clock synchronized data transmission, so as to make sure that the processor device 24 performs the decoding operation precisely. When the respective LED devices mounted on the LED arrays are placed in a bright or a dark state upon being driven by the time-varying mutually orthogonal driving signals, the solar cell 9 converts the light energy radiated from the light source into electricity. According to this embodiment, the processor device 24 includes a digital signal processor for receiving the current signals output from the solar cell and for multiplying the respective driving signals transmitted from the ARM controller 201 by the current signals from the solar cell 9. Since the digital signal processor may function as a multiplier, the component signals contributed by the respective LED devices can be obtained by multiplying the overall light detected value by the respective driving signals according the relationships

$$S ( n ) = {\sum }_{i = 1}^{30} \frac{1}{2} Ii ( 1 + {a}_{i} ( n ) ) ,$$

n=1, 2, . . . 32;

$${\sum }_{n = 1}^{32} S ( n ) {a}_{1} ( n ) = {\sum }_{n = 1}^{32} {\sum }_{i = 1}^{30} \frac{1}{2} ( 1 + {a}_{1} ( n ) ) Ii \cdot {a}_{1} ( n ) .$$

Given that the optical energy levels radiated from the respective LED devices are known (in output power levels), the energy conversion efficiencies of the solar cell 9 with respect to the respective wavelength ranges of the respective LED devices can be obtained by comparing the component signals to the respective optical energy levels radiated from the LED devices. The measurement apparatus disclosed herein involves dividing the main spectral energy distribution of sunlight into, for example, 10 wavelength intervals and measuring the response of the solar cell 9 as a function of the optical energy generated in the respective wavelength intervals, thereby achieving a precise classification of the solar cell.

Furthermore, the luminous intensity of the light source would decay over time due to aging, with individual LED devices decaying at different rates. The light source of the measurement apparatus disclosed herein can be calibrated to compensate for the decay by carrying out a measurement of a well-characterized solar cell with known performance.

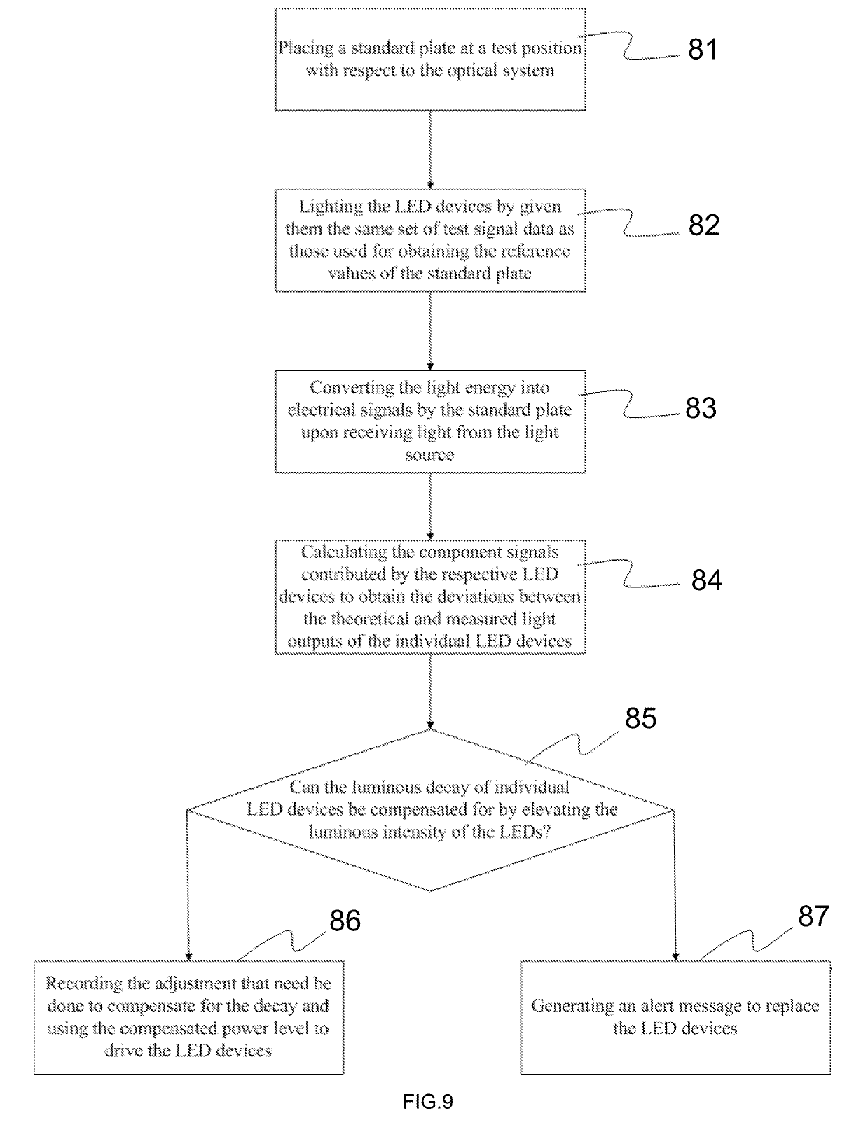

For example, when the measurement apparatus is used for a period of time and need to be calibrated, a solar cell with known spectral response is placed at a test position with respect to the optical system and serves as a standard plate, as described in Step 81 of FIG. 9. Next, in Step 82, the respective LED devices are given the same set of test signal data as those used beforehand for obtaining the spectral response of the standard plate, so that they are placed in the bright or dark state according to the same mutually orthogonal driving signals. In Step 83, the standard plate receives the optical energy from the light source and converts the same into electrical signals. In Step 84, the electrical signals are multiplied by the driving signals to give the component signals contributed by the respective LED devices. By virtue of referring to the spectral response of the standard plate, the deviations between the theoretical and measured light outputs of the individual LED devices are obtained, and from there the luminous decay levels of the individual LED devices can be calculated.

Finally, in Step 85, the luminous decay of individual LED devices is examined to see if it can be tuned to compensate for the decay. If the answer is YES, then the adjustment that need be done to compensate for the decay is recorded in Step 86 and the compensated power level will be used later to drive the corresponding LED device. If the answer to the query in Step 85 is NO, indicating that the decay of the LED device is beyond what can be compensated for by adjusting the output power level, an alert message is generated in Step 87 to inform maintenance personnel to replace the LED device with a new one.

It is understood by those skilled in the art that, in an alternative embodiment, the luminous decay is only recorded but not compensated for. The recorded decay levels of the respective LED devices are taken into account during calculation of the component signals contributed by the respective LED devices. By virtue of the process disclosed herein, the light source of the measurement apparatus can be readily calibrated.

While the invention has been described with reference to the preferred embodiments above, it should be recognized that the preferred embodiments are given for the purpose of illustration only and are not intended to limit the scope of the present invention and that various modifications and changes, which will be apparent to those skilled in the relevant art, may be made without departing from the spirit and scope of the invention.

What is claimed is:

1. A process for measuring a spectral response of a solar cell by using a light-emitting diode (LED) array as a light source for emitting light towards the solar cell, the LED array comprising at least one group of LED devices with each group having a plurality of LED devices, wherein the LED devices are capable of emitting multiple types of light having different central wavelengths from one another and the different types of light have a total number equal to or less than the total number of the LED devices, the process comprising the steps of:
a) powering the at least one group of LED devices to emit light in a synchronized manner by providing a set of test signal data composed of multiple test signals, wherein the test signals are mutually orthogonal to one another and have an output power level corresponding to at least one known power level;
b) converting detected values generated by the solar cell upon detecting light from the group of LED devices powered by the set of test signal data into detected electric signals; and
c) using a processor device to separate component signals contributed by the respective LED devices from the detected electric signals and compare the component signals to the output power level corresponding to the set of test signal data and/or to the respective optical energy levels radiated from the respective LED devices, thereby obtaining the spectral response of the solar cell to the different wavelengths of light.

2. The process for measuring a spectral response of a solar cell according to claim 1, wherein the step c) of separating the component signals contributed by the respective LED devices and comparing the component signals to the output power level further comprises the sub-steps of:
c1) multiplying the respective test signals of the test signal data with the detected electric signals, so that portions of the detected electric signals which are orthogonal to the test signals multiplied therewith and noise portions of the detected electric signals which are independent from the test signals are calibrated to be zero;
c2) comparing the respective component signals corresponding to the respective test signals to the corresponding output power level and/or to the respective optical energy levels radiated from the corresponding LED devices to obtain the energy conversion efficiency corresponding to the respective test signals, and defining the spectral response of the solar cell with respect to the respective central wavelengths of light emitted from the respective LED devices powered according to the respective test signals; and
c3) performing calculation with respect to the respective central wavelengths of light to obtain the overall spectral response of the solar cell.

3. The process for measuring a spectral response of a solar cell according to claim 1, wherein the mutually orthogonal test signals in the step a) are generated based on the CDMA technology.

4. The process for measuring a spectral response of a solar cell according to claim 1, further comprising, before the step a), a step d) of measuring respective luminous intensities of the respective LED devices as powered by the output power level.

5. An apparatus for measuring a spectral response of a solar cell, comprising:
a light-emitting diode (LED) array comprising at least one group of LED devices with each group having a plurality of LED devices, wherein the LED devices are capable of emitting multiple types of light having different central wavelengths from one another and the different types of light have a total number equal to or less than the total number of the LED devices;
a driver device for powering the at least one group of LED devices to emit light in a synchronized manner by providing a set of test signal data composed of multiple test signals, wherein the test signals are mutually orthogonal to one another and have an output power level corresponding to at least one known power level; and
a processor device for converting detected values generated by the solar cell upon detecting light from the group of LED devices powered by the set of test signal data into detected electric signals, and for separating component signals contributed by the respective LED devices from the detected electric signals and comparing the component signals to the output power level corresponding to the set of test signal data and/or to the respective optical energy levels radiated from the respective LED devices, thereby obtaining the spectral response of the solar cell to the different wavelengths of light.

6. The apparatus for measuring a spectral response of a solar cell according to claim 5, wherein the driver device comprises a plurality of driver circuits for outputting the test signals to power the respective LED devices to emit light, wherein the test signals are mutually orthogonal to one another and have an output power level corresponding to at least one known power level.

7. The apparatus for measuring a spectral response of a solar cell according to claim 5, wherein the driver device further comprises a CDMA encoder for encoding the mutually orthogonal test signals.

8. The apparatus for measuring a spectral response of a solar cell according to claim 5, wherein the LED light source array includes at least three LED devices capable of emitting light with central wavelengths of red, green and blue light, respectively.

9. The apparatus for measuring a spectral response of a solar cell according to claim 5, wherein the processor device comprises a digital signal processor for separating the component signals contributed by the respective LED devices by multiplying the respective test signals of the test signal data with the detected electric signals, and for comparing the respective component signals to the corresponding output power level and/or to the respective optical energy levels radiated from the corresponding LED devices to obtain the energy conversion efficiency corresponding to the respective test signals, and defining the spectral response of the solar cell with respect to the respective central wavelengths of light emitted from the respective LED devices powered according to the respective test signals, and for obtaining the overall spectral response of the solar cell by performing calculation with respect to the respective central wavelengths of light.

10. A process for compensating for decay of a light source mounted on an apparatus used for measuring the quantity of electrical energy converted by a solar cell under test, wherein the light source is a light-emitting diode (LED) array for emitting light towards the solar cell, the LED array comprising at least one group of LED devices with each group having a plurality of LED devices, wherein the LED devices are capable of emitting multiple types of light having different central wavelengths from one another and the different types of light have a total number equal to or less than the total number of the LED devices, and wherein the apparatus is stored with reference spectral response values of at least one reference solar cell having a known spectral response to the different wavelengths of light emitted from a standard light source, the process comprising the steps of:
e) placing the at least one reference solar cell having known spectral response at a test position where the solar cell under test is to be placed;
f) powering the at least one group of LED devices to emit light in a synchronized manner by providing a set of test signal data composed of multiple test signals, wherein the test signals are mutually orthogonal to one another and have an output power level corresponding to at least one known power level;
g) converting detected values generated by the reference solar cell upon detecting light from the group of LED devices powered by the set of test signal data into detected electric signals; and
h) using a processor device to separate component signals contributed by the respective LED devices from the detected electric signals and compare the component signals to the reference spectral response values with respect to the different wavelengths of light, thereby obtaining the deviations of luminous intensity between the light source and the standard light source over the different wavelengths of light.

11. The process for compensating for decay of a light source according to claim 10, wherein the step h) of separating the component signals contributed by the respective LED devices and comparing the component signals to the reference spectral response values further comprises the sub-steps of:
h1) multiplying the respective test signals of the test signal data with the detected electric signals, so that portions of the detected electric signals which are orthogonal to the test signals multiplied therewith and noise portions of the detected electric signals which are independent from the test signals are calibrated to be zero;
h2) comparing the respective component signals corresponding to the respective test signals to the reference spectral response values corresponding to the standard light source, and defining the deviations of luminous intensity of the light source with respect to the respective central wavelengths of light emitted from the respective LED devices powered according to the respective test signals; and
h3) performing calculation with respect to the respective central wavelengths of light to obtain the deviations of luminous intensity of the light source over all of the different central wavelengths.

12. The process for compensating for decay of a light source according to claim 10, wherein the apparatus further comprises a driver device for powering the light source to emit light by providing the set of test signal data, and wherein the process further comprises, after the step h), a step i) of adjusting the set of test signal data to compensate for the deviations of luminous intensity between the light source and the standard light source with respect to the respective wavelengths of light.

13. The process for compensating for decay of a light source according to claim 10, wherein the apparatus further comprises a driver device for powering the light source to emit light by providing the set of test signal data, and the driver device has a predetermined upper limit for power output, and wherein the process further comprises the steps of:
j) after the step h) of obtaining the deviations of luminous intensity between the light source and the standard light source with respect to the respective wavelengths of light, determining whether, if the set of test signal data are adjusted into an adjusted set of test signal data to compensate for the deviations of luminous intensity, any of the test signals in the adjusted set of test signal data will result in an output power exceeding the predetermined upper limit for output power;
k) if there is no any test signal in the adjusted set of test signal data that will result in an output power exceeding the predetermined upper limit for output power, allowing the set of test signal data to be adjusted into the adjusted set of test signal data to compensate for the deviations of luminous intensity between the light source and the standard light source with respect to the respective wavelengths of light;
l) if there exists at least one test signal in the adjusted set of test signal data that will result in an output power exceeding the predetermined upper limit for output power, adjusting the at least one test signal to that which will lead to an output power equal to the predetermined upper limit for output power; and
m) recording the adjusted signal of the at least one test signal which will lead to an output power equal to the upper limit for output power, so as to allow the processor device to perform compensation based on the recorded adjusted signal during a later operation of the apparatus.
